(19) United States
(12) Patent Application Publication
(10) Pub. No.: US 2026/0051097 A1
(43) Pub. Date: Feb. 19, 2026

(54) INFORMATION PROCESSING APPARATUS, PROGRAM, AND INFORMATION PROCESSING METHOD

(71) Applicant: LY CORPORATION, Tokyo (JP)

(72) Inventors: Atsuki OSANAI, Tokyo (JP); Nghia TRUONG, Tokyo (JP); Shuhei YOKOO, Tokyo (JP); Yamato OKAMOTO, Tokyo (JP); Masayoshi KONDO, Tokyo (JP); Yoshihisa IJIRI, Tokyo (JP); Toshinori SATO, Tokyo (JP); Mitsuharu MAKITA, Tokyo (JP)

(73) Assignee: LY CORPORATION, Tokyo (JP)

(21) Appl. No.: 19/369,773

(22) Filed: Oct. 27, 2025

Related U.S. Application Data
(63) Continuation of application No. PCT/JP2024/016327, filed on Apr. 25, 2024.

(30) Foreign Application Priority Data
Apr. 27, 2023 (JP) 2023-073635

(51) Int. Cl. G06T 11/60; G06F 40/106; G06F 40/109; G06Q 30/0242; G06T 11/00; G06T 11/20

(52) U.S. Cl. CPC G06T 11/60; G06F 40/106; G06F 40/109; G06Q 30/0242; G06T 11/001; G06T 11/203; G06T 2200/24

(57) ABSTRACT

An information processing apparatus includes an acquisition device that acquires input information, and an output device that generates content using a first element and a second element different from the first element, from the input information such that the content is acquired based on different elements.

### CROSS-REFERENCE TO RELATED APPLICATIONS

This application is a continuation of, and claims the benefit of priority under 35 U.S. C. §§ 120 and 365(c) from PCT International Application No. PCT/JP2024/016327, which has an international filing date of Apr. 25, 2024 and claims priority to Japanese Application No. 2023-073635, filed Apr. 27, 2023, the entire contents of each of which are hereby incorporated by reference.

### BACKGROUND

The present disclosure relates to an information processing apparatus, a program, an information processing method, and the like.

There is interest in techniques for automatically generating advertisement text. However, conventionally, it may be difficult to acquire content such as a catchphrase, a product description, a product image, an advertisement, a flyer, a poster, and/or a work of art, which are based on a plurality of different elements.

### SUMMARY

At least some example embodiments are directed to a method for acquiring content that is based on different elements, from input information.

According to some example embodiments, an information processing apparatus includes: an acquisition device configured to acquire input information; and an output device configured to output content generated using a first element and a second element different from the first element, from the input information.

According to some example embodiments, a program executed by the information processing apparatus causes the information processing apparatus to execute: acquiring input information by an acquisition device of the information processing apparatus; and outputting, by an output device of the information processing apparatus, content generated using a first element and a second element different from the first element, from input information.

According to some example embodiments, an information processing method of an information processing apparatus includes: acquiring input information by an acquisition device of the information processing apparatus; and outputting, by an output device of the information processing apparatus, content generated according to a first element and a second element different from the first element, from input information.

In some example embodiments, an information processing apparatus may include a controller configured to, acquire input information including at least one of a first text and a first image; and generate content using a first element and a second element from the input information such that the content generated includes a second image; and an output device configured to output the content generated by the controller, wherein the first element is second text, and the second element is different from the first element and includes at least one of: (i) a layout of the second text in the second image, and (ii) a color of the second image.

In some example embodiments, the controller is configured to generate a plurality of pieces of the content, and the information processing apparatus further includes a selection device configured to select the content from among the plurality of pieces of the content based on input performed by a user.

In some example embodiments, the controller is further configured to acquire the input information based on the content generated by the output device.

In some example embodiments, the content is an advertisement, and the controller is further configured to acquire effectiveness information related to an effectiveness of the advertisement.

In some example embodiments, a non-transitory computer readable medium storing a program that when executed by an information processing apparatus, configures the information processing apparatus to acquire input information including at least one of a first text and a first image; generate content using a first element and a second element from the input information such that the content that is generated includes a second image; and output the content, wherein the first element is second text, and the second element is different from the first element and includes at least one of: (i) a layout of the second text in the second image, and (ii) a color of the second image.

In some example embodiments, an information processing method for an information processing apparatus, includes acquiring, by a controller of the information processing apparatus, input information including at least one of a first text and a first image;
generating, by the controller of the information processing apparatus, content using a first element and a second element from the input information such that the content generated by the output device includes a second image; and outputting, by an output device of the information processing apparatus, the content generated by the controller, wherein the first element is second text, and the second element is different from the first element and includes at least one of: (i) a layout of the second text in the second image, and (ii) a color of the second image.

In some example embodiments the layout is based on a layout pattern generated based on a designation by a user of the information processing apparatus.

In some example embodiments, the layout is based on a layout pattern generated based on at least one of the input information and the first element.

In some example embodiments, the second element includes a color of the second image, and the color of the second image includes a color of the second text in the second image.

In some example embodiments, the input information further includes a style of the content, and the second element is based on the input information.

In some example embodiments, the second element includes a color of the second image, the color being based on the input information.

In some example embodiments, the second element further includes a font style of the second text in the second image.

In some example embodiments, a prompt sentence for generating the first element or the second element is generated based on the input information, and the first element or the second element is generated based on the prompt sentence.

In some example embodiments, the controller is configured to generate at least one of the first element and the second element, and the content.

In some example embodiments, the content is generated using a large-scale language model and an image generation model.

In some example embodiments, the controller is configured to generate the content using a large-scale language model to generate the second text based on a prompt sentence derived from the input information, and an image generation model to generate the second image incorporating the second text according to the second element.

In some example embodiments, the information processing apparatus further includes a storage device configured to store previously generated ones of the second element, wherein the controller is configured to generate the content based on the input information and at least one second element retrieved from the storage device.

In some example embodiments, the controller includes an image recognition model configured to extract text data or features from the first image to derive the first element or the second element.

In some example embodiments, the first element and the second element are parameters used to generate the content, the controller is configured to store, within a material database, the content and the parameters used to generate the content, and the controller is configured to generate new content by adjusting at least one of the parameters used to generate the content.

In some example embodiments, the parameters include at least one of a layout pattern, a font style, or a color scheme, and wherein the controller is configured to adjust the at least one of the parameters to generate the new content based on a refinement request from a user.

### BRIEF DESCRIPTION OF DRAWINGS

FIG. 1-1 is a diagram showing an example of a configuration of an information processing apparatus according to a first example embodiment.

FIG. 1-2 is a flowchart showing an example of a flow of main processing of artwork generation according to the first example embodiment.

FIG. 1-3 is a diagram illustrating an example of a screen displayed on a display of the information processing apparatus.

FIG. 1-4 is a diagram showing an example of a configuration of an information processing apparatus according to a first modification.

FIG. 2-1 is a diagram showing an example of a configuration of an information processing apparatus according to a second example embodiment.

FIG. 2-2 is a diagram showing an example of the configuration of the information processing apparatus according to the second example embodiment.

FIG. 2-3 is a flowchart showing an example of a flow of main processing of artwork generation according to the second example embodiment.

FIG. 3-1 is a diagram showing an example of a configuration of an information processing apparatus according to a third example embodiment.

FIG. 3-2 is a flowchart showing an example of a flow of main processing of artwork generation according to the third example embodiment.

FIG. 4-1 is a diagram showing an example of a configuration of an information processing apparatus according to a fourth example embodiment.

FIG. 4-2 is a flowchart showing an example of a flow of main processing of artwork generation according to the fourth example embodiment.

FIG. 5-1 is a diagram showing an example of a configuration of an information processing apparatus according to a fifth example embodiment.

FIG. 5-2 is a flowchart showing an example of a flow of main processing of artwork generation according to the fifth example embodiment.

FIG. 6-1 is a flowchart showing an example of a flow of processing executed by a terminal and a server according to an application example.

### DETAILED DESCRIPTION

### Compliance with Legal Requirements

It should be noted that the disclosure described herein is premised on compliance with legal requirements such as secrecy of communication in a country in which the present disclosure is to be implemented.

### EXAMPLE EMBODIMENTS

The phrase “in a non-limiting example” is used in some parts of the present specification for ease of understanding, but it should be noted that not only those parts but the entirety of the following embodiments is not limited to the content described therein.

The following describes embodiments for implementing a program and the like according to the present disclosure with reference to the drawings.

Production of the information processing apparatus of at least some example embodiments may, in a non-limiting example, encompass the concept of creating a state in which the function can be realized in the present information processing apparatus by receiving a program (in a non-limiting example, a dialog program) or the like described in the present specification (or by receiving and storing the program or the like in an information processing apparatus).

Production of the terminal of at least some example embodiments may, in a non-limiting example, encompass the concept of creating a state in which the function can be realized in the present terminal by receiving a program (in a non-limiting example, an application program) or the like described in the present specification (or by receiving and storing the program or the like in a terminal), in a terminal owned by (possessed by) a user.

Also, production of the system of at least some example embodiments may, in a non-limiting example, encompass the concept of creating a state in which the function can be realized by receiving a program (in a non-limiting example, an application program) or the like that is described in the present specification and transmitted from a server included in the system of the present application (or by receiving and storing the program or the like in a terminal) with the terminal included in the system of present application.

In a non-limiting example, if the terminal is a smartphone or a personal computer (PC), an application received from a server may be incorporated (installed) in that smartphone or PC and some of the elements (processing/operation) as claimed in the present application may be executed via that application. Also, in a non-limiting example, if the terminal is a smartphone or a PC, some elements (processing/operation) as claimed in the present application may be executed via a website accessible from the smartphone or PC without incorporating (installing) an application in the smartphone or PC.

In addition, in the present specification, in a non-limiting example, the term “system” can include a plurality of apparatuses (which may also be referred to as information processing apparatuses).

The plurality of apparatuses may be a combination of apparatuses of the same type, a combination of apparatuses of different types, or a combination of apparatuses of the same type and apparatuses of different types.

Note that, in a non-limiting example, the system can also be considered as a plurality of apparatuses cooperating to perform some kind of processing.

In a non-limiting example, a “system related to a client (client device) and a server”can be considered as at least one of the following:
(1) a terminal and a server;
(2) a server; and
(3) a terminal.

In the case (1), the system includes at least one terminal and at least one server, in a non-limiting example. The system in this example is a client-server system.

The server includes the following devices, which may be a single device or a combination of a plurality of devices, in a non-limiting example.

Specifically, in a non-limiting example, the server may have any of at least one processor (in a non-limiting example, a CPU: Central Processing Unit, a GPU: Graphics Processing Unit, an APU: Accelerated Processing Unit, a DSP: Digital Signal Processor (in a non-limiting example, an ASIC: Application Specific Integrated Circuit, an FPGA: Field Programmable Gate Array), etc.), a computer apparatus (a processor and a memory), a control apparatus, an arithmetic apparatus, and a processing apparatus, and may include two or more of any of the above apparatuses of the same type (in a non-limiting example, two CPUs, a homogeneous multi-core processor, etc.) or include two or more of any of the above apparatuses of different types (in a non-limiting example, a CPU and a DSP, a heterogeneous multi-core processor, etc.), or may be a combination of two or more apparatuses (in a non-limiting example, a processor and a computer device, a processor and an arithmetic apparatus, a heterogeneous configuration of two or more devices, etc.).

Note that the processor may be a virtual processor.

When the server that includes a single apparatus executes a certain type of processing, the single device executes the processing described in the example embodiments. If the server includes a plurality of apparatuses, one apparatus may execute a part of the processing and another apparatus may execute the other part of the processing. In a non-limiting example, if the server includes a processor and an arithmetic apparatus, the processor may execute first processing and the arithmetic apparatus may execute second processing.

If the server includes a plurality of apparatuses, the devices may be disposed at locations physically separated from each other.

Functions of the server may be provided in the form of PaaS, IaaS, or SaaS in cloud computing, in a non-limiting example.

A controller of the system can be at least either a controller of the terminal or a controller of the server. That is, in a non-limiting example, any of the following can be the controller of the system: (1A) only the controller of the terminal; (1B) only the controller of the server; and (1C) both the controller of the terminal and the controller of the server.

Control and processing (hereinafter collectively referred to as “control and the like”) performed by the controller of the system may be: (1A) performed only by the controller of the terminal; (1B) performed only by the controller of the server; or (1C) performed by both the controller of the terminal and the controller of the server.

In the case (1C), in a non-limiting example, a part of control and the like performed by the controller in the system may be performed by the controller of the terminal, and the remaining part of the control and the like may be performed by the controller of the server. In this case, the allocation of the control and the like may be equal or different from the equal allocation.

If the server is constituted by a single apparatus, the term “a communication device of the server” may refer to a communication device included in the single apparatus. If the server is constituted by a plurality of apparatuses, the communication device of the server may include communication devices included in the respective apparatuses.

In a non-limiting example, if the server includes a first apparatus and a second apparatus, the first apparatus has a first communication device, and the second apparatus has a second communication device, the term “a communication device of the server” may refer to a concept that includes the first communication device and the second communication device.

In the case (2), the system may include a plurality of servers (hereinafter referred to as a “server system”), in a non-limiting example. In this case, the aforementioned configuration can be similarly applied to each of the servers.

Control and the like performed by the server system may be performed by: (2A) only one of the plurality of servers; (2B) only another one of the servers; or (2C) one server and another server out of the plurality of servers.

In the case (2C), in a non-limiting example, a part of control and the like performed by the server system may be performed by one server, and the remaining part of the control and the like may be performed by another server. In this case, the allocation of the control and the like may be equal or different from equal allocation.

In the case (3), the system may include a plurality of terminals, in a non-limiting example.

In a non-limiting example, this system can be as follows:
a system in which the terminals have server functions (distributed system), which can be realized by using a blockchain technology, in a non-limiting example; or
a system in which the terminals wirelessly communicate with each other, which can be realized by performing communication in a P2P (peer-to-peer) method or the like using a short-range wireless communication technology, such as Bluetooth (registered trademark), in a non-limiting example.

Note that the above is not limited to the controller, but also applies to functional devices such as an input/output device, a communication device, a storage, and a clock that can be constituent elements of the system.

In the following embodiments, a system that includes a terminal and a server (in a non-limiting example, a client-server system) will be described, in a non-limiting example.

Note that the server system of the above case (2) can be applied as the server.

Instead of the system that includes a terminal and a server, the system of the above case (3) can be applied as a system that does not include a server, in a non-limiting example.

An embodiment in this case can be configured based on the aforementioned blockchain technology or the like. Specifically, data stored and managed in a server that will be described in the following embodiments is kept (stored) on a blockchain, in a non-limiting example. The terminal generates a transaction to the blockchain, and data kept on the blockchain can be updated if the transaction is approved on the blockchain.

Note that even if the term “terminal” is used, this is not limited to the meaning of a terminal as a client device in a client-server system.

That is, the term “terminal” may include a concept of a device that is not included in a client-server.

Regarding the phrases “related to” and “associated with” used herein, “B related to A” and “B associated with A” may mean that B has a certain relationship with A, in a non-limiting example.

When a device performs processing targeting two or more objects, e.g., “transmitting A and B” or “receiving A and B” herein, the processing may be performed at the same timing for A and B (hereinafter referred to as “synchronously”) or at different timings for A and B (hereinafter referred to as “asynchronously”).

In a non-limiting example, when first information and second information are transmitted, this may include both concepts of transmitting the first information and the second information at the same timing and transmitting the first information and the second information at different timings.

Note that, considering a lag (time lag), “synchronously” may include “substantially synchronously”.

Note that when it is stated that processing is performed at different timings for A and B, this need only mean that the processing is performed targeting A and B, and the purpose does not necessarily need to be the same.

In a non-limiting example, when it is stated that the first information and the second information are transmitted as mentioned above, the first information and the second information need only be transmitted, and this may include a case where the first information and the second information are transmitted for the same purpose as well as a case where the first information and the second information are transmitted for different purposes.

Some example embodiments will be described below.

In the following example embodiments, in a non-limiting example, a method for generating content such as catchphrase, a product description, and a product image, and a method for generating content such as an advertisement using these will be illustrated.

In the following example embodiments, content such as an advertisement serving as a final product is referred to as “artwork”for the sake of convenience.

Note that a catchphrase, a product description, a product image, and the like serving as intermediate products may be types of content, and these may also be outputtable. A keyword may also be included in the content.

As used herein, expressions such as “at least one of,” when preceding a list of elements, modify the entire list of elements and do not modify the individual elements of the list. Thus, for example, both “at least one of A, B, or C” and “at least one of A, B, and C” mean either A, B, C or any combination thereof. Likewise, A and/or B means A, B, or A and B.

While the term “same,” “equal” or “identical” is used in description of example embodiments, it should be understood that some imprecisions may exist. Thus, when one element is referred to as being the same as another element, it should be understood that an element or a value is the same as another element within a desired manufacturing or operational tolerance range (e.g., ±10%).

When the term “about,” “substantially” or “approximately” is used in this specification in connection with a numerical value, it is intended that the associated numerical value includes a manufacturing or operational tolerance (e.g., ±10%) around the stated numerical value. Moreover, when the word “about,” “substantially” or “approximately” is used in connection with geometric shapes, it is intended that precision of the geometric shape is not required but that latitude for the shape is within the scope of the disclosure. Further, regardless of whether numerical values or shapes are modified as “about” or “substantially,” it will be understood that these values and shapes should be construed as including a manufacturing or operational tolerance (e.g., ±10%) around the stated numerical values or shapes.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of example embodiments.

### First Example Embodiment

A first example embodiment is an example embodiment relating to a basic configuration for realizing the generation of content.

The description in the first example embodiment can be applied also to any of the other example embodiments and other modifications.

In addition, the same constituent elements as those that are already described are denoted by the same reference numerals, and redundant description thereof is omitted.

### Functional Configuration of Information Processing Apparatus

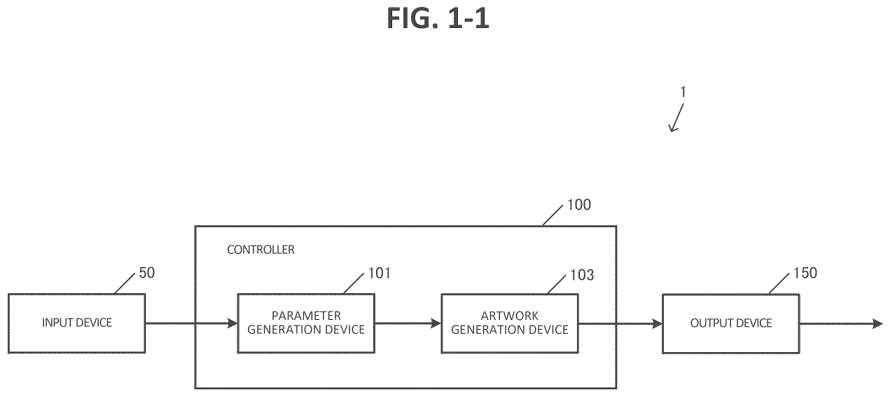

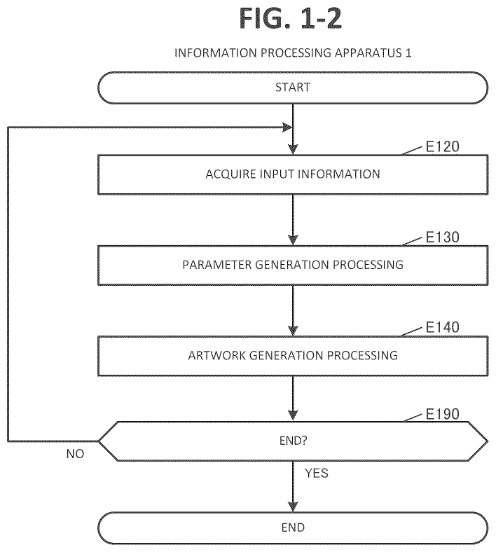

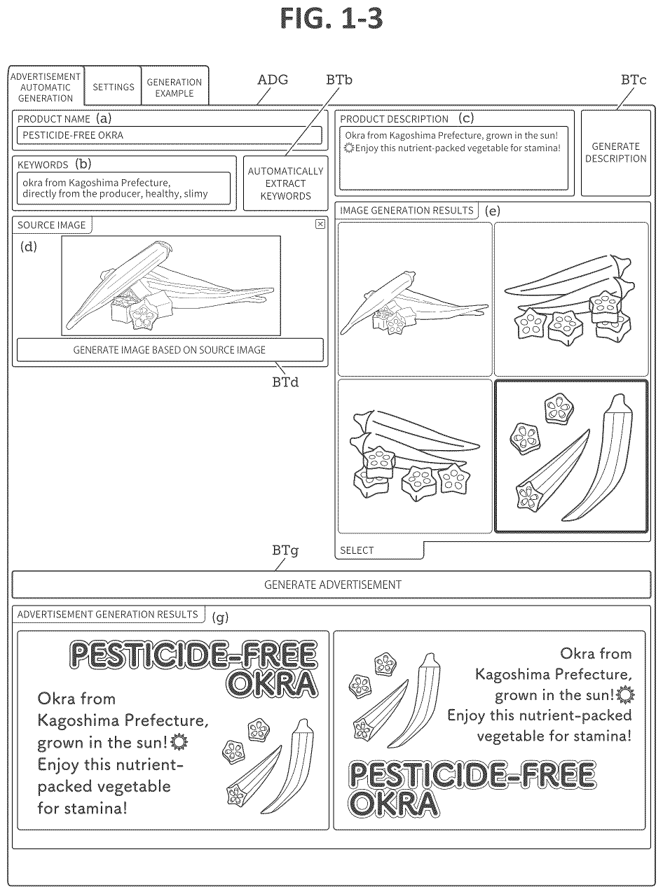

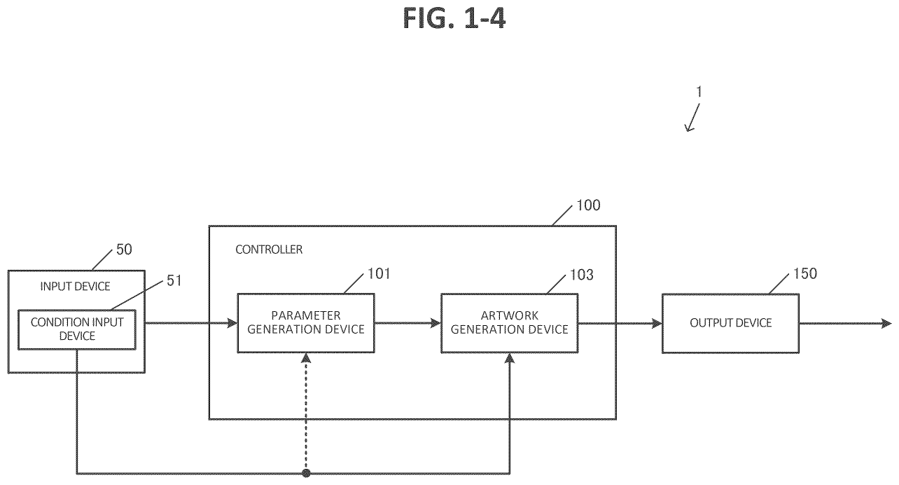

FIG. 1-1 is a block diagram showing an example of a functional configuration of an information processing apparatus 1 according to an embodiment of the present disclosure.

In a non-limiting example, the information processing apparatus 1 includes, in a non-limiting example, a parameter generation device 101 and an artwork generation device 103 as one of the functional devices included in a controller 100. In a non-limiting example, these functional devices may be constituted by circuits such as a central processing unit (CPU), a microprocessor, a processor core, a multiprocessor, an ASIC, or an FPGA.

In a non-limiting example, the parameter generation device 101 generates a parameter (parameter for artwork generation) used by the artwork generation device 103 to generate artwork based on input information input via an input device 50. The parameter generated by the parameter generation device 101 is referred to as a “generated parameter” in some cases.

In the present specification, description will be given using the term “parameter” for convenience, but this may be regarded as an element included in artwork (information included in artwork), an element for generating artwork (information for generating artwork), and the like.

Note that the input device 50 may be provided outside the information processing apparatus 1.

In a non-limiting example, the input device 50 may be realized by any of all types of apparatuses that can receive input from the user and transmit information related to the input to the information processing apparatus 1, or by a combination of some of them.

In a non-limiting example, the input device 50 may include hardware keys such as a touch panel, a touch display, and a keyboard, and may include a pointing device such as a mouse, a camera (operational input performed via a moving image), and a microphone (operational input performed via audio).

In the present example embodiment, in a non-limiting example, text data may be input to the input device 50 by the user as input information.

In a non-limiting example, the text data may be text data (text data that has not been made into an image) such as a character string input (or output) in text format. Characters that have been made into an image based on text data may also be regarded as “image information”.

In a non-limiting example, the text data may be a name or the like of a product or service for which artwork is to be generated, and any text data may be input.

Text data input to the input device 50 is referred to as “input text data”in some cases.

Note that, in a non-limiting example, the information input to the input device 50 may be constituted by only data other than text data (non-limiting examples of which include image data such as a still image or a moving image, and sound data such as audio) or may include data other than text data in addition to the text data.

The image data input to the input device 50 is referred to as “input image data”in some cases.

In a non-limiting example, the parameter generation device 101 may output (A) text as a parameter based on at least the input information (in a non-limiting example, input text data) input by the input device 50.

In a non-limiting example, (A) the text in this context may mean a character string in text format (text that has not been made into an image).

Outputting the (A) text as a parameter may, in a non-limiting example, include outputting text different from the input text data input as input information.

Here, the “different text” may include, in a non-limiting example, some or all of the input text data being included in (A) the text output by the parameter generation device 101. If all of the input text data is included in (A) the text output by the parameter generation device 101, (A) the text is generated in a form in which newly generated text is added to the input text data. Non-limiting examples include a case where, if the input text data is “okra”, (A) the text that is output is “okra grown in the sun”.

Another example of the “different text” may also include a case where some or all of the input text data is not included in (A) the text output by the parameter generation device 101. Non-limiting examples thereof include a case where, if the input text data is “okra”, (A) the text that is output is “vegetable for stamina, grown in the sun”.

In a non-limiting example, (A) the text may include a catchphrase, a product description, a keyword, or the like.

In a non-limiting example, the parameter generation device 101 may output (B) an image as a parameter, in addition to or instead of (A) the text.

Non-limiting examples of (B) the image include:
an image such as an illustration or photograph that does not include text;
an image such as an illustration or photograph including text; and
text that has been made into an image (an image obtained by making a character string in text format into an image).

Note that an image is not limited to a still image, and may also be a moving image.

In addition to these, in a non-limiting example, the following parameters may also be included.
(C) A layout pattern
(D) A style of artwork (may include a pop style, a warm style, a cool style, etc.)
(E) A background color of artwork (may include an image color of the artwork)

In a non-limiting example, (C) the layout pattern may be a pattern in which a position or a region in which text is disposed in the artwork is set, a pattern in which a position or a region in which an image is disposed in the artwork is set, a pattern in which a position or a region in which text and an image are arranged in the artwork is set, and the like.

In a non-limiting example, (A) the text and (B) the image generated by the parameter generation device 101 may be generated based on at least one of the following elements.
(a) A color of characters of the text
(b) A font style of characters of the text
(c) A color of the image

In a non-limiting example, (a) the color of the characters of the text may be an element defining at least one of the color of the characters of the text that has not been made into an image or the color of the characters of the text that has been made into an image.

In a non-limiting example, (b) the font style of the characters of the text may be an element defining at least one of the font style of the characters of the text that has not been made into an image or the font style of the characters of the text that has been made into an image. Note that, in a non-limiting example, the font style may include the type of font, the font size, the font color, and the font family.

In a non-limiting example, (c) the color of the image may be an element defining the color of (B) the image.

Note that this may include the color of text that has been made into an image, which may be considered to be (a) the color of the characters of the text that has been made into an image above.

The parameter generation device 101 may generate at least two parameters among the above parameters (A) to (E) or (a) to (c).

In a non-limiting example, the parameter generation device 101 may be constituted by a model such as a language model module or an image generation model module.

In a non-limiting example, the language model for the language model module may include various language models or large-scale general-purpose language models such as a Sequence to Sequence model such as Transformer, or an autoregressive model such as GPT.

Note that a model other than these may also be included.

In a non-limiting example, the language model module may generate (A) the text based on the input text data.

In a non-limiting example, the image generation model of the image generation model module may include a model such as a Text-to-Image model, a diffusion model, and a Generic Adversarial Network (GAN) (non-limiting examples of which may include Deep Convolutional GAN (DCGAN), etc.). In a non-limiting example, the image generation model of the image generation model module may also include an image-to-image model (non-limiting examples of which include conditional GAN (cGAN), etc.).

Note that a model other than these may also be included.

In a non-limiting example, the image generation model module may generate (infer) (B) an image based on (A) text generated by the language model module.

Note that, in a non-limiting example, the image generation model module may infer (B) an image based on input text data.

In a non-limiting example, the image generation model module may infer (B) an image based on input image data.

Alternatively, (A) the text generated by the language model module may be output as a parameter as-is.

Also, in a non-limiting example, the parameter generation device 101 may include a model or the like for selecting and outputting a font style corresponding to the input text data or the like (in a non-limiting example, a decision tree generated using boosting, etc.).

The same applies also to (a) the color of the characters of the text, (c) the color of the image, and the like.

Note that, in a non-limiting example, the font style may also be selected based on (A) the text, (B) the image, and the like.

In a non-limiting example, (E) the background color of the artwork may also similarly be selected based on the input text data, (A) the text, (B) the image, and the like.

Also, in a non-limiting example, the parameter generation device 101 may determine the font style based on (D) the style of the artwork.

In a non-limiting example, if (D) the style of the artwork is “pop style”, in a non-limiting example, a Gothic bold typeface in which the characters appear in a pop style on the artwork may be selected as the font style. This is because, in a non-limiting example, if the font style is stiff, the style of the artwork will give a stiff impression, and if the font style is soft, the style of the artwork will give a soft impression.

Note that the same may apply also to (E) the background color of the artwork.

The artwork generation device 103 generates artwork based on the generated parameters. Artwork generated by the artwork generation device 103 is referred to as “generated artwork” as appropriate.

The artwork generation device 103 generates artwork that is based on a first element and a second element that is different from the first element.

Specifically, in a non-limiting example, artwork is generated by, for example, arranging and rendering (A) text (a non-limiting example of the first element) and (B) an image (a non-limiting example of the first element) generated by the parameter generation device 101 based on the above-described (C) layout pattern (a non-limiting example of the second element), or by automatically arranging and rendering them.

In this case, when (D) the style of the artwork and (E) the background color of the artwork are included in the generated parameters, the artwork generation device 103 can arrange the text and the image in the layout pattern in which the style and the background color serve as the basis.

In this example, in a non-limiting example, the artwork generation device 103 may be regarded as an artwork composition device, a rendering device, or the like.

In a non-limiting example, an example in which the first element is (A) the text and the second element is the font style or size of the characters of (A) the text may also be included in the case where the artwork generation device 103 generates artwork that is based on the first element and the second element different from the first element. In a non-limiting example, an example in which the first element is (B) the image and the second element is the color of (B) the image may also be included in this. That is, in a non-limiting example, the second element may be an element related to the output mode of the first element.

Note that the artwork generation device 103 may include, in a non-limiting example, a model such as a neural network, such as a DNN (in a non-limiting example, a GAN). In this case, a trained model that is trained by learning the layout pattern may be constructed, and may be configured as a model that receives as input an input vector constituted by at least an element of the generated parameters.

Here, as (C) the layout pattern, one of the following may be used.
A layout pattern created in advance by the user
A layout pattern generated as a parameter by the parameter generation device 101

Note that when a layout pattern created in advance by the user is used as (C) the layout pattern, the user may designate it through the input device 50. This will also be described in later-described pattern A and First Modification (2).

In a non-limiting example, when the parameter generation device 101 generates a layout pattern, the layout pattern may be generated using a layout generation model realized by LayoutGAN or the like. In a non-limiting example, a layout pattern may be generated using a model proposed by Ueno et al. (Michihiko Ueno, Shin'ichi Satoh, Continuous and Gradual Style Changes of Graphic Designs with Generative Model, IUI '21: 26th International Conference on Intelligent User Interfaces April 2021 Pages 280-289).

More specifically, as a non-limited example, any of the following may be applied as an implementation pattern.

<Pattern A> A Pattern in which Artwork is Generated using a Layout Pattern
(Pattern A1) A pattern in which the user creates and inputs a layout pattern in advance

When various generated parameters (not including a layout pattern) are input from the parameter generation device 101, the artwork generation device 103 generates artwork by arranging text and an image based on the layout pattern created in advance by the user.

Note that, in a non-limiting example, the artwork generation device 103 may generate artwork by arranging text and an image based on a template layout pattern set in advance by the user of the system.

Note that in the case of pattern A1, the user may designate the layout pattern via the input device 50 as described above. This will also be described in First Modification (2) below.
(Pattern A2) A pattern in which the parameter generation device 101 generates a layout pattern

When various generated parameters (including a layout pattern) are input from the parameter generation device 101, the artwork generation device 103 generates artwork by arranging text and an image based on the input layout pattern.
(Pattern A3) A pattern in which the artwork generation device 103 generates a layout pattern

When various generated parameters (not including a layout pattern) are input from the parameter generation device 101, in a non-limiting example, the artwork generation device 103 generates a layout pattern, and generates artwork by arranging text and an image based on the generated layout pattern.

<Pattern B> A Pattern in which Artwork is Generated without using a Layout Pattern

In a non-limiting example, when various generated parameters (not including a layout pattern) are input from the parameter generation device 101, in a non-limiting example, the artwork generation device 103 generates artwork by, for example, randomly arranging text and an image.

The artwork generated by the artwork generation device 103 can be output from the output device 150.

The output device 150 may be realized by, in a non-limiting example, any of all types of apparatuses that can output the processing results processed by the information processing apparatus 1, or by a combination of some of them.

In a non-limiting example, the output device 150 may include a touch panel, a touch display, a lens (in a non-limiting example, 3D (three Dimensions) output or hologram output), a printer, or the like.

Note that the term “output” in this context may include at least one of the following.
Output of internal information of the apparatus itself (output of information from one functional device to another, etc.)
Display on a display apparatus (display apparatus of an external apparatus, display apparatus of the information processing apparatus 1)
Transmission to an external apparatus (transmission by a communication apparatus of the information processing apparatus 1)

The external apparatus may include, in a non-limiting example, a terminal or the like of the user, as described below.

### Processing

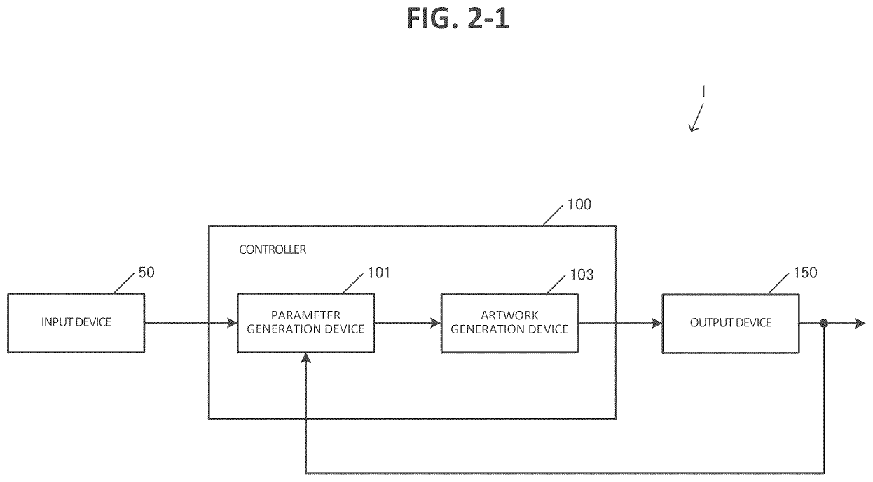

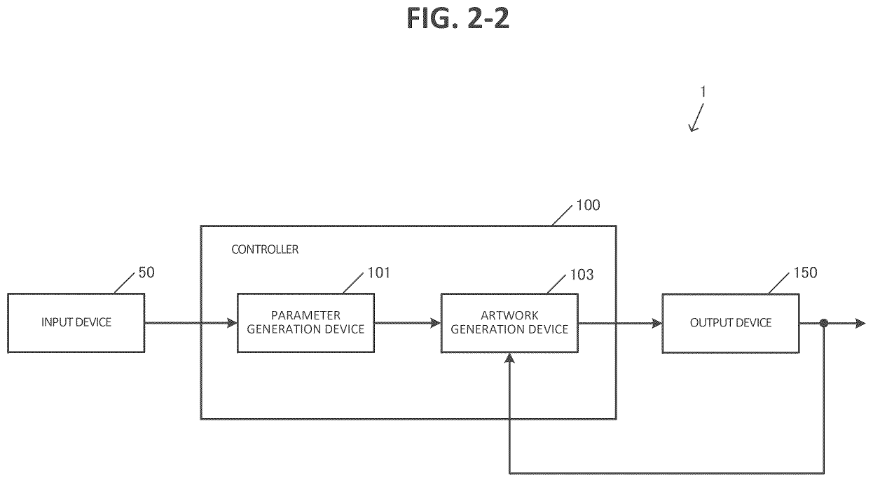

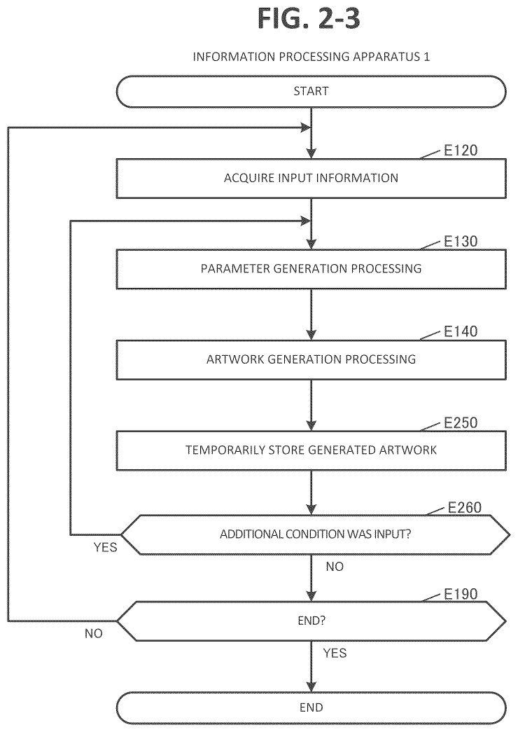

FIG. 1-2 is a flowchart showing an example of a flow of main processing of artwork generation (hereinafter referred to as “artwork generation main processing”) executed by the controller 100 of the information processing apparatus 1 in this example embodiment.

First, the controller 100 acquires input information (in a non-limiting example, text data, etc.) to the input device 50 (E120).

Next, the parameter generation device 101 performs parameter generation processing based on the acquired input information (E130).

Here, a method using a question sentence will be illustrated as an example of one method for generating a parameter. In the following description, a sentence (character string) input to the model will be referred to as a “prompt sentence” (prompt character string).

In a non-limiting example, a template of the question sentence such as the following is stored in advance in the parameter generation device 101. Then, in a non-limiting example, the parameter generation device 101 generates a prompt sentence to be input to a language model module constituted by a large-scale general-purpose language model or the like, based on the text data and the question sentence.

More specifically, in a non-limiting example of a question, the following questions may be stored.
(Q1) What color do you imagine when you hear <X>?
(Q2) What is your impression of <X>?
(Q3) What is a catchphrase for <X>?
(Q4) Is <X> cool? Or is it cute?

Note that it is assumed that X is substituted with text data such as the product name mentioned above.

In a non-limiting example, if the input text data is “okra”, a prompt sentence is generated that is input to the language model module and that enables the language model module to infer an answer sentence for each of the above question sentences.
(Q1) What color do you imagine when you hear the word <okra>?
(Q2) What is your impression of <okra>?
(Q3) What is a catchphrase for <okra>?
(Q4) Is <okra> cool? Or is it cute?

When these prompt sentences are input to the language model module, the language model module infers and outputs answer sentences to the respective question sentences.
(A1) Green.
(A2) Packed with nutrition.
(A3) Not only packed with nutrition, but also regulates the intestines and suppresses blood sugar levels, making it perfect for preventing summer fatigue.
(A4) More on the cute side.

Note that the parameter generation device 101 may be, in a non-limiting example, a prompt sentence that is input to the language model module in accordance with the input text data and the above-mentioned answer sentences (A1) to (A4), and the language model module may generate a prompt sentence for inferring a product description based on the input text data. In this case, in a non-limiting example, the prompt sentence may be as follows.

“Generate a product description for <X>. <X> is (A1). Also, <X> is (A2). Also, <X> is (A3). Also, <X> is (A4).”

The language model module then infers and outputs a product description in accordance with the generated prompt sentence.

Note that the questions are not limited to the above questions.

In addition, the prompt sentence for generating the product description may include any of the answer sentences to the question sentences, all of the answer sentences, or none of the answer sentences.

Next, based on this answer sentences, the image generation model module generates an image such as the following, in a non-limiting example. In a non-limiting example, if <X> is “okra”, then image generation may be as follows.
(I1) An image of <okra>
(I2) An image of the text “okra” in a “green”, “more on the cute side” font style.
(I3) An image of the text “Not only packed with nutrition, but also regulates the intestines and suppresses blood sugar levels, making it perfect for preventing summer fatigue”, in a “more on the cute side” font style.

In this case, in a non-limiting example, at least one of the above-mentioned answer sentences may be used to determine the font style of the characters (text).

In a non-limiting example, the answer sentence (A4) “More on the cute side” may be input into a model that selects a font style, and based on this input, a font style (in a non-limiting example, a pop typeface) that matches this text may be selected.

Thereafter, the artwork generation device 103 performs artwork generation processing for generating artwork based on the generated parameters (E140).

Specifically, in a non-limiting example, the above text and images are arranged based on a layout pattern and rendered to generate an image that serves as artwork.

The generated artwork is output from the output device 150.

Next, the controller 100 determines whether or not to end the processing (E190), and if it determines that the processing is to be continued (E190: NO), the processing is returned to step E120.

If it is determined that the processing is to be ended (E190: YES), the controller 100 ends the processing.

Note that, as mentioned above, the artwork generation device 103 may, in a non-limiting example, arrange and render text generated by the language model module and images generated by the image generation model module based on a layout pattern to generate artwork.

As described above, image data such as a source image may also be input to the input device 50 instead of or in addition to text data (input image data).

The image data may be, in a non-limiting example, image data input (or output) in an image format such as JPEG.

In a non-limiting example, the input image data may be an image of the entire artwork (may include a conceptual image of the entire artwork, etc.), or may be an image of a portion of the artwork (may include an image to be included as-is in the artwork, a conceptual image of an image to be included in the artwork, etc.).

In this case, the parameter generation device 101 may be configured to have an image recognition model including, in a non-limiting example, an image classification model, an image classification/object position specification model, an object detection model, a segmentation model (in a non-limiting example, a semantic segmentation model, an instant segmentation model, a panoptic segmentation model), or the like.

Then, the parameter generation device 101 may generate parameters based on the results of image recognition performed by the image recognition model.

### Display Screen Examples

Hereinafter, some techniques for generating advertisements as artwork will be described in more detail with reference to display screen examples.

As shown in FIG. 1-3, an advertisement generation screen ADG is displayed on a display (not shown) of the information processing apparatus 1.

Note that such a display may be realized by an application executed on the information processing apparatus 1 (in a non-limiting example, an advertisement generation application).

Keyword Generation from Product Name

The advertisement generation screen ADG of the present mode includes, in a non-limiting example, a product name region (a), a keyword automatic extraction button Btb, and a keyword region (b).

A user attempting to generate an advertisement inputs the name of the product for which the advertisement is to be generated (in a non-limiting example, an example of information related to content (including information related to the advertisement)) into the product name region (a) in the input device 50 and taps the keyword automatic extraction button Btb, and thereby, in a non-limiting example, in step E120 of the processing in FIG. 1-2, the controller 100 (in a non-limiting example, an example of an acquisition device) acquires the input information. In this example, text data is acquired as input information.

Note that the input device 50 may be regarded as an acquisition device that acquires input information in addition to or instead of the controller 100. The same applies to the description below.

Then, in step E130 of the processing in FIG. 1-2, in a non-limiting example, the parameter generation device 101 acquires a distributed representation corresponding to the product name from the product name, based on a model capable of acquiring a distributed representation (vector representation) of a word, such as Word2Vec.

Next, in a non-limiting example, in step E130 of the processing in FIG. 1-2, the parameter generation device 101 generates words corresponding to the respective distributed representations as keywords based on distributed representations distributed within a predetermined distance from the distributed representation of the product name. That is, in this example, text serving as a keyword different from the input text data is generated as an element (first element) for generating artwork.

Note that the model capable of acquiring a distributed representation of a word may be an inference-based technique such as Word2Vec, or a count-based method such as N-gram.

The one or more keywords generated in this manner are output to the keyword region (b).

In this example, the user inputs the product name “pesticide-free okra” in the product name region (a) and taps the keyword automatic extraction button Btb, and based on this, keywords generated based on the product name, such as okra from Kagoshima Prefecture, directly from the producer, healthy, and slimy, are output in the keyword region (b).

Product Image Generation from [Product Name+Keywords]

The advertisement generation screen ADG of this mode includes an image generation result region (e).

In a non-limiting example, in step E130 of the processing in FIG. 1-2, the parameter generation device 101 generates a predetermined number (in this example, four) of product images (a non-limiting example of content images (including advertisement images)) using, in a non-limiting example, a Text-to-Image model, based on a prompt character string constituted by the product name in the product name region (a) and one or more keywords in the keyword region (b). Note that the predetermined number may also be “1”. That is, in this example, an image is generated as an element (first element) for generating artwork.

The generated product image may be a photograph-style image or an illustration-style image. The generated predetermined number of product images are displayed in the image generation result region (e).

Here, in the Text-to-Image model, the prompt character string is first converted (encoded) into an embedded representation using an encoding model such as RNN or Transformer.

Then, based on the embedded representations, the Text-to-Image model generates product images using, in a non-limiting example, a diffusion model.

Note that the Text-to-Image model may also generate product images based on the embedded representations using a VAE (Variational Autoencoder) or GAN.

Product Image Generation from Source image (User-Set Image)

The advertisement generation screen ADG of the present mode includes a source image region (d) and an image generation button BTd for obtaining an image generation result based on a source image in the source image region (d).

Instead of image generation results obtained based solely on the prompt character string (in a non-limiting example, the product name displayed in the product name region (a) and/or one or more keywords displayed in the keyword region (b)) input to the Text-to-Image model, the user can also obtain image generation results based on an image selected by the user, an image obtained as an image search result from an Internet search performed based on the product name and/or one or more keywords, or the like.

The image search results may be either automated search results from a search performed by an application, such as an advertisement generation application, or manual search results from a search performed by the user.

In a non-limiting example, due to the user displaying the image to be used as the source image in the source image region (d) via the input device 50 (setting it as the source image) and tapping the image generation button BTd, in a non-limiting example, the controller 100 acquires input information in step E120 of the processing of FIG. 1-2. In this example, image data is acquired as input information.

Then, in step E130 of the processing of FIG. 1-2, in a non-limiting example, the parameter generation device 101 generates a predetermined number (in this example, “four”) of product images based on at least the image in the source image region (d), and displays the generated product images in the image generation result region (e). Note that the predetermined number may also be “one”.

That is, in this example, an image is generated as an element (first element) for generating artwork.

In a non-limiting example, a predetermined number of product images may be generated using an Image-to-Image model without using a prompt character string and using only the set source image.

Note that if the source image is a photograph-style image, the Image-to-Image model may generate a product image by mapping the source image onto an illustration-style image using a conditional GAN (cGAN) or the like.

On the other hand, the parameter generation device 101 may also use a prompt character string and a set source image to operate a decoder based on an embedded representation generated using a Text-to-Image model encoder and an Image-to-Image model encoder and generate a product image.

Note that the source image can be converted into an embedded representation using a VAE, Transformer, or the like, and then combined with the embedded representation of the product name+keywords to generate an image using a diffusion model or GAN, thereby generating an illustration-style product image based on the source image and the product name+keywords.

In addition, various filters such as contour extraction may be applied to the source image to generate an illustration-style product image (or the product image may be used as the source image for input).

Product Description Generation from [Product Name+Keywords]

The advertisement generation screen ADG of the present mode includes a product description region (c) where a product description is displayed, and a description generation button BTc for generating a product description.

In a non-limiting example, due to the user tapping the description generation button BTc, in a non-limiting example, in step E130 of the processing in FIG. 1-2, the parameter generation device 101 creates, based on a set template, a prompt sentence instructing generation of a product description including the product name in the product name region (a) and one or more of the keywords in the keyword region (b).

In a non-limiting example, a product description is generated based on the prompt sentence using a Text-to-Text model such as BART (Bidirectional Auto-Regressive Transformer), GPT (Generative Pre-trained Transformer), or T5 (Text-to-Text Transfer Transformer). The prompt sentence may enable the user to perform product description settings by which it is possible to designate the length of the product description, the style of the product description (pop style, formal style, etc.), and the like. That is, in this example, text is generated as an element (first element) for generating artwork.

Note that instead of using a prompt sentence instructing generation of a product description, the product description may also be generated by a Text-to-Text model fine-tuned for advertisement copywriting, based on the product name and keywords.

The prompt sentence may also include words based on the source image or the image that is the image generation result. In this case, the words corresponding to the image may be inferred using a Contrastive Language-Image Pre-training (CLIP) model or the like.

The product description generated in this manner is displayed in the product description region (c).

Advertisement Generation from [Product Name+Product Description+Product Image]

The advertisement generation screen ADG of the present mode includes an advertisement generation result region (g) in which a generated advertisement image is displayed, and an advertisement generation button BTg for generating an advertisement image.

In a non-limiting example, due to the user selecting an image to be used in an advertisement from the product images in the image generation result region (e) (in this example, the product image in the lower right corner is selected) and tapping the advertisement generation button BTg, in a non-limiting example, in step E130 of FIG. 1-2, the parameter generation device 101 creates, based on a set template, a prompt sentence instructing the generation of a product description including the product name in the product name region (a), the product description in the product description region (c), and the selected product image (hereinafter referred to as “selected image”).

In a non-limiting example, in step E130 of FIG. 1-2, the parameter generation device 101 determines a product name region for rendering the product name, a product description region for rendering the product description, and a selected image region for disposing the selected image, using LayoutGAN or the like. That is, in this example, a layout pattern is generated as an example of a second element that is an element for generating artwork and relates to the output mode of the first element.

Note that, as mentioned above, the layout pattern may also be provided by the user.

Upon determining the layout of each region, the font point size (a non-limiting example of font size) for rendering the product name is calculated based on the size of the product name region and the number of characters in the product name. Note that if the number of characters in the product name is greater than the width of the product name region, wrapping of the character string may be automatically performed within the product name character string. In addition, the font and style (font color, bold, italics, etc.) for rendering the product name may be selected by the parameter generation device 101 as described above, may be a pre-set font and style, or may be a font and style designated by the user. That is, in this example, the color, font style, and the like of the characters of the text are generated as an example of a second element that is an element for generating artwork and relates to the output mode of the first element.

Note that the font and style may be automatically determined based on the product name and keywords. In this case, the product name and keywords may be subjected to text classification using a Transformer model or the like, and fonts and styles associated with the classified category results may be applied.

Similarly, for the product description, the font point size, style, and character string wrapping settings for rendering may also be executed with respect to the product description region.

Next, in a non-limiting example, in step E140 of FIG. 1-2, the artwork generation device 103 generates a predetermined number (in this example, “two”) of advertisement images (an advertisement and image data serving as output results) serving as advertisement generation results based on the layout of each region and the rendering settings in each region. This advertisement image is an example of image data and an example of generated artwork.

A predetermined number of advertisement images generated in this manner are displayed in the advertisement generation result region (g). This is an example of artwork being output from the output device 150.

Note that the product name may be rendered based on the information in the product name region (a), the product description may be rendered based on the information in the product description region (c), and then, based on the rendered product name image and product description image, and the selected image, the layout of each image element may be inferred using LayoutGAN or the like, and an advertisement image may be generated that combines the product name image, product description image, and selected image based on the inference results.

Note that in the above-described example, a product image is generated based on the input product name (the product name displayed in the product name region (a)) and keywords automatically generated based on the product name (the keywords output in the keyword region (b)). However, there is no limitation to this mode, and a product image may be generated based on the input product name and input keywords (in a non-limiting example, keywords displayed in the keyword region (b) as a result of the user inputting the keywords in this region).

In addition, a product image may be generated based on the product name, keywords (in a non-limiting example, automatically generated keywords or keywords input by the user), and a product description that is automatically generated based on the product name and keywords.

That is, the prompt character string to be input to the Text-to-Image model may include a product description.

In addition, in the above-described example, a product description is generated based on the input product name (the product name displayed in the product name region (a)) and keywords automatically generated based on the product name (keywords output in the keyword region (b)). However, there is no limitation to this mode, and the product description may be generated based on the input product name and input keywords (in a non-limiting example, keywords that are displayed in the keyword region (b) due to the user inputting the keywords in this region).

In addition, in the above-described example, based on the user inputting a product name in the product name region (a), keywords may then be automatically generated based on the product name and output to the keyword region (b) without the need for user operation, a predetermined number of product images may be automatically generated based on the product name, keywords, and the like and output to the image generation result region (e), a product description may be automatically generated based on the product name, keywords, and the like and output to the product description region (c), and a predetermined number of advertisements may be automatically generated based on the product name, product description, and any product image (in a non-limiting example, an automatically selected product image) and output to the advertisement generation result region (g).

That is, after the user inputs the product name, an automatically generated advertisement image may be displayed without the user performing any operation to obtain the output of a keyword, product image, product description, and advertisement image.

Also, in a non-limiting example, if the user does not select an image from the image generation results, a product description (which may or may not be an image) may be output as the generation result.

### Regarding the Information Processing Apparatus

The information processing apparatus 1 may be regarded as a type of content generation apparatus or output apparatus.

In this case, the information processing apparatus 1 may be capable of outputting, as content, artwork such as advertisements (advertisement images) serving as final products generated by the artwork generation device 103, as well as catchphrases (in a non-limiting example, may be images of a catchphrase with (a) the color of the characters of the text as the second element, or a catchphrase with (b) the font style of the characters of the text as the second element) serving as intermediate products generated by the parameter generation device 101, product descriptions (in a non-limiting example, may be images of a product description with (a) the color of characters of the text as the second element, or a product description with (b) the font style of the characters of the text as the second element), and product images (in a non-limiting example, a product image or the like with (c) the color of the image as the second element). The same may also be applied below.

In this example embodiment, the artwork generation device 103 generates artwork based on the generated parameters output from the parameter generation device 101.

In this case, the generated parameters may be regarded as corresponding to “input information”, and the artwork generation device 103 may be regarded as generating artwork that is based on a first element and a second element different from the first element, based on the input information.

In addition, in the above-described example embodiment, the parameter generation device 101 and the artwork generation device 103 are separate functional devices, but the parameter generation device 101 and the artwork generation device 103 may constitute an “artwork generation device”. That is, the input information may be input to an artwork generation device to generate artwork.

In addition, in the above-described example embodiment, the parameter generation device 101 generates parameters based on information and the like input by the user, but this may also be regarded as the parameter generation device 101 generating elements of artwork based on input information. That is, the parameter generation device may be regarded as a functional device that generates elements of content based on input information.

In addition, an information processing apparatus including the parameter generation device 101 may be configured, and the information processing apparatus may output the parameters generated by the parameter generation device 101. In this case, the information processing apparatus may be, in a non-limiting example, an apparatus including a generation device that generates elements of content such as artwork (may be regarded as elements or information used to generate content) based on input information.

Such an information processing apparatus may be regarded as a type of generation device or output device that generates elements or parts used to generate content such as artwork.

### Effects of First Example Embodiment

This example embodiment describes a configuration in which the information processing apparatus 1 acquires input information such as text data, and outputs content such as a catchphrase, product description, product image, and advertisement from the acquired input information.

As an example of an effect of the example embodiment obtained by such a configuration, it is possible to output content generated using a first element and a second element different from the first element from acquired input information.

Note that the information processing apparatus 1 may also be considered as an apparatus that generates content that is based on the first element and the second element, based on the acquired input information.

The content may also be generated using at least the first element and the second element.

In this example embodiment, the input information includes text data, and the content includes at least one of text data and image data.

As an example of the effect of the example embodiment obtained by such a configuration, content including at least one of text data and image data can be generated and output based on input information including text data.

This example embodiment describes a configuration in which the input information includes image data, and the content includes at least one of text data and image data.

As an example of an effect of the example embodiment obtained by such a configuration, content including at least one of text data and image data can be generated and output based on input information including image data.

In addition, this example embodiment describes a configuration in which the second element is an element related to the output mode of the first element generated based on input information.

As an example of an effect of the example embodiment obtained by such a configuration, content generated using a first element and a second element that is related to the output mode of the first element generated based on the input information can be output from the acquired input information.

In this case, the first element may be text, and the second element may include at least one of the color of the characters of the text and the font style of the characters of the text.

As an example of an effect of the example embodiment obtained by such a configuration, it is possible to output text and content generated by at least one of the color of the characters of the text and the font style of the characters of the text.

In this case, the input information may be text data, and the first element may be text that is different from the text of the input information.

As an example of an effect of the example embodiment obtained by such a configuration, it is possible to output content generated using text different from the text of the text data of the input information.

In addition, the content may be image data such as an advertisement image, the first element may be text, and the second element may include at least one of the layout (in a non-limiting example, the layout pattern) of the text in the image of the image data such as the advertisement image and the color of the image.

As an example of an effect of the example embodiment obtained by such a configuration, it is possible to output content generated using the text and at least one of the layout of the text in an image of image data that is content, and the color of the image.

The information processing apparatus according to the first example embodiment may acquire input information, such as text or image data, and output content generated using distinct first and second elements, like text and its layout or color in an image, therefore providing improved automated content creation systems that enable the generation of visually coherent outputs, such as advertisements, from diverse inputs without manual intervention, thereby enhancing computational efficiency in rendering devices, reducing processing overhead in iterative design tasks, improving inference speed and data consistency.

### First Modification (1)

Instead of acquiring text data or image data input by the user, in a non-limiting example, the information processing apparatus 1 may acquire text data or image data stored in a database (not shown), and perform processing similar to that described above.

In a non-limiting example, when a business (company, etc.) uses the information processing apparatus 1 to generate artwork for an advertisement, it may acquire some of the text data of the advertisement stored in the database and image data of that advertisement from the database and perform processing similar to that described above.

More specifically, in a non-limiting example, in a messaging application (a non-limiting example of a chat application), if an advertisement that has already been distributed to general users and the like using what is called an official account (a business account) is stored in a database, the text data and image data of the advertisement for which the version is to be updated, which is selected by the user via the input device 50, may be acquired from the database, and processing similar to that described above may be performed.

### First Modification (2)

In a non-limiting example, a user may be able to designate the conditions used to generate content such as artwork.

FIG. 1-4 is a block diagram showing an example of a functional configuration of the information processing apparatus 1 according to this modification.

In a non-limiting example, the configuration of the information processing apparatus 1 is the same as that of FIG. 1-1, but the input device 50 has a condition input device 51.

A parameter or a partial element thereof is input to the condition input device 51 as a condition. The condition input to the condition input device 51 is output to at least one of the functional devices of the parameter generation device 101 and the artwork generation device 103.

In a non-limiting example, the user may be able to designate at least one of (a) the color of the characters of the text, (b) the font style of the characters of the text, and (c) the color of the image, which were described above, as a condition.

Also, in a non-limiting example, the user may be able to designate at least one of (C) the layout pattern, (D) the style of the artwork, and (E) the background color of the artwork, which were described above, as a condition.

In a non-limiting example, when the color of the characters of the text is input as a condition, the parameter generation device 101 may generate and output text colored in the input color.

In a non-limiting example, if the background color of the artwork is input as a condition, the artwork generation device 103 may generate the artwork by arranging and rendering text and images in a layout pattern based on the background color of the input artwork.

In the above-mentioned example of <okra>, if “background color of artwork=green” is input as a condition, the artwork generation device 103 may generate artwork by arranging text and images in a layout pattern in which green is the background color.

This modification shows a configuration in which the input information includes condition information (a non-limiting example of setting information relating to at least one of the first element and the second element) input by the user.

As an example of the effect of the modification obtained by such a configuration, content generated by the first element and the second element can be output based on input information input by a user, the input information including setting information relating to at least one of the first element and the second element.

In this case, the input information may include at least input text data and condition information related to the second element input by the user, the content may be image data such as an advertisement image, the first element may be text obtained based on the input text data, and the second element may include one or more of the color of the characters of the text in the image of the image data such as an advertisement image, the font style of the characters of the text in this image, the layout of the text in this image, and the color of the image, which are based on the condition information related to the input second element.

As an example of an effect of the modification obtained by such a configuration, based on input information input by a user, which includes at least text data and setting information related to a second element, it is possible to output content generated using a first element, which is text that is based on the text data, and a second element, which includes one or more of the color of the characters of the text in an image of image data that is content, the font style of the characters of the text in this image, the layout of the text in this image, and the color of this image, the second element being based on the setting information.

### First Modification (3)

Although partially illustrated in the display screen example as well, the parameter generation device 101 may generate a plurality of product descriptions and product images. Furthermore, the artwork generation device 103 may generate a plurality of pieces of artwork. That is, the information processing apparatus 1 may generate a plurality of pieces of content.

In this case, in a non-limiting example, the artwork generation device 103 may generate artwork multiple times with different combinations of elements of the generated parameters.

Also, in this case, the information processing apparatus 1 may display the generated plurality of pieces of content on the display of the apparatus itself. In addition, the generated plurality of pieces of content may be transmitted to an external apparatus (in a non-limiting example, a terminal of a user), and the external apparatus may display the received plurality of pieces of content on a display.

The information processing apparatus 1 may then determine the content selected based on input performed by the user of the apparatus itself or the user of the external apparatus to select the content, as the final content.

In this modification, the information processing apparatus 1 outputs a plurality of pieces of generated content and selects content based on input performed by the user.

As an example of an effect of the modification obtained by such a configuration, it is possible to enable the user to select content in accordance with the user's intent from among a plurality of pieces of generated content.

### Second Example Embodiment

The second example embodiment is an example embodiment related to repeating a cycle of content generation using generated content.

The description in the second example embodiment can be applied to any of the other example embodiments and other modifications.

In addition, the same constituent elements as those already mentioned are denoted by the same reference numerals and redundant description thereof is omitted.

FIG. 2-1 is a block diagram showing an example of a functional configuration of the information processing apparatus 1 according to this example embodiment.

The functional blocks of this information processing apparatus 1 are the same as those in FIG. 1-1, but in this example, the latest generated artwork (artwork generated last time) is fed back to the parameter generation device 101. Also, the parameter generation device 101 is configured to generate parameters based on the generated artwork that has been fed back.

In this case, the user need only input text data or image data the first time, and does not need to input it the second time and onward.

In a non-limiting example, the parameter generation device 101 acquires information that can be used as input information from the generated artwork that is fed back, and generates parameters based on the acquired information.

In a non-limiting example, the parameter generation device 101 may include the above-described image recognition model, and may perform image recognition on the artwork that has been fed back to acquire text data or the like that can be used as input information.

Note that in this case, the configuration shown in FIG. 1-4 may be applied, and the parameter generation device 101 may generate parameters based on the generated artwork that is fed back and input and the conditions input to the condition input device 51.

As another example of the configuration of FIG. 2-1, the generated artwork may be fed back to the artwork generation device 103 as shown in FIG. 2-2, in a non-limiting example.

In this case, in a non-limiting example, the configuration shown in FIG. 1-4 may be applied, and the artwork generation device 103 may generate artwork based at least on the generated artwork that has been fed back and the conditions input to the condition input device 51. Specifically, in a non-limiting example, the artwork may be generated by performing processing for modifying (adjusting) the generated artwork that has been fed back, based on additional conditions.

In the above-mentioned example of <okra>, in a non-limiting example, if the background color of the artwork being “green” has been input as a condition, the artwork generation device 103 can generate artwork by arranging text and images in a layout pattern in which green is the background color, while leaving elements other than the background color of the fed-back artwork as they are.

Note that the generated parameters generated by the parameter generation device 101 may also be fed back to the parameter generation device 101. In this case, in a non-limiting example, the configuration shown in FIG. 1-4 may be applied and the parameter generation device 101 may generate parameters based on at least the generated parameters that were fed back and the conditions input to the condition input device 51. Specifically, in a non-limiting example, parameters may be generated by performing processing for modifying (adjusting) the fed-back generated parameters based on additional conditions.

In the above-mentioned example of <okra>, in a non-limiting example, if the color of the characters of the text being “green” is input as a condition, the artwork generation device 103 may generate and output a product description that has been made into an image in which the color of characters of the text has been modified to green, the product description serving as a fed-back generated parameter, in a non-limiting example.

### Processing

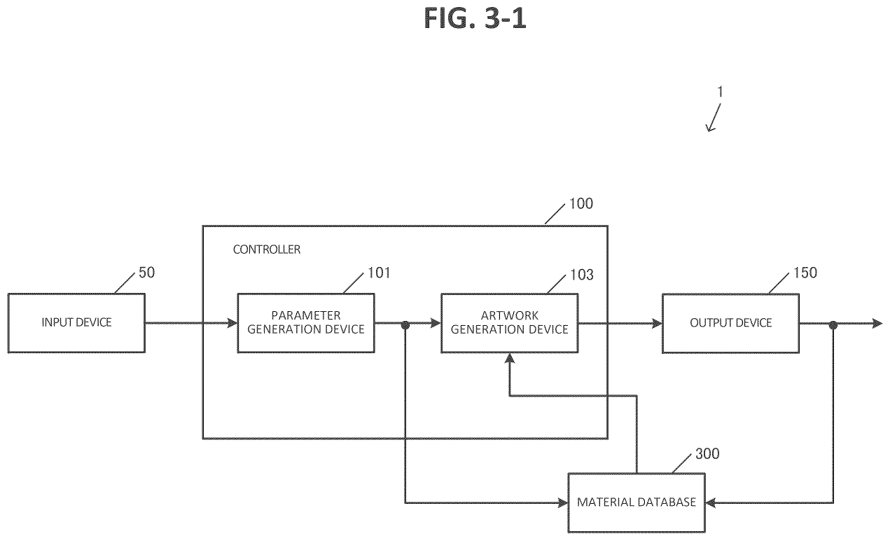

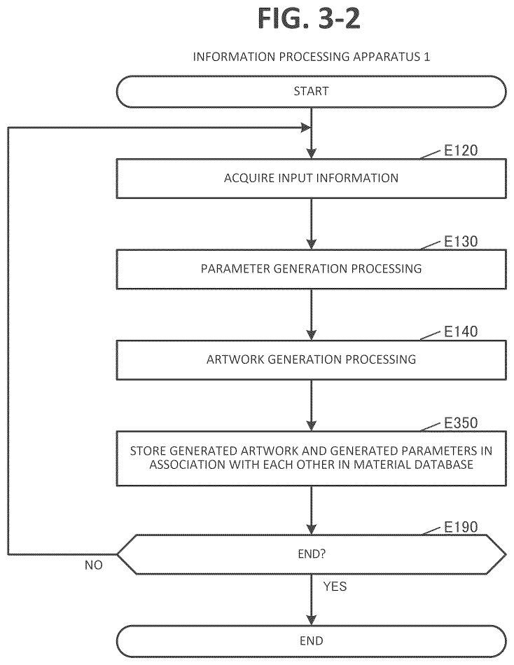

FIG. 2-3 is a flowchart showing an example of a flow of processing executed by the controller 100 of the information processing apparatus 1 in this example embodiment.

After step E140, the controller 100 temporarily stores the generated artwork in the storage (E250).

Next, the controller 100 determines whether or not an additional condition has been input via the input device 50 (E260).

If no additional condition has been input (E260: NO), the controller 100 proceeds to step E190, in a non-limiting example.

If an additional condition has been input (E260: YES), the controller 100 returns the processing to step E130, in a non-limiting example. Then, the parameter generation device 101 generates parameters based on the additional condition and the generated artwork temporarily stored in the storage.

Note that, in a non-limiting example, the controller 100 returns the processing to step E140. Then, the artwork generation device 103 may generate artwork based on the generated parameters obtained in the previous step E130, the generated artwork that was temporarily stored, and the additional conditions.

### Effects of Second Example Embodiment

This example embodiment shows a configuration in which the information processing apparatus 1 acquires input information that is based on generated content (a non-limiting example of input information that is based on content output by an output device), and outputs content generated using a first element and a second element based on the acquired input information.

As an example of an effect of an example embodiment obtained by such a configuration, input information that is based on the content output by the output device can be acquired, and the content can be regenerated and output.

The information processing apparatus according to the second example embodiment may implement a feedback mechanism where generated content is reused as input for subsequent generations, forming a closed-loop system, therefore providing automated adjustment based on additional conditions, improving the adaptability and precision of AI-driven models like language and image generation modules, which reduces computational waste from redundant processing and enhances the system's ability to converge on optimized outputs, such as refined advertisements, representing a technological advancement in dynamic content systems.

### Third Example Embodiment

A third example embodiment is an example embodiment that enables the artwork generated by the artwork generation device 103 and the parameters generated by the parameter generation device 101 to be used for generating content from the next time and onward.

The description in the third example embodiment can be applied to any of the other example embodiments and other modifications.

In addition, the same constituent elements as those already mentioned are denoted by the same reference numerals and redundant description thereof is omitted.

FIG. 3-1 is a block diagram showing an example of a functional configuration of the information processing apparatus 1 according to this example embodiment.

The functional blocks included in this information processing apparatus 1 include, in addition to the configuration shown in FIG. 1-1, a material database 300, in a non-limiting example. The controller 100 is configured to associate generated artwork with the generated parameters that were the basis for generating the generated artwork, and store them cumulatively (accumulatively) in the material database 300.

The artwork generation device 103 may, in a non-limiting example, generate artwork using at least one of the generated parameters stored in the material database 300. In this way, some parameters can be reused to generate artwork.

In this case, in a non-limiting example, artwork may be generated using at least one of (a) the color of the characters of the text, (b) the font style of the characters of the text, (c) the color of the image, and the like among the generated parameters stored in the material database 300.

Note that, additionally, artwork may be generated using at least one of (C) the layout pattern, (D) the style of the artwork, and (E) the background color of the artwork among the generated parameters stored in the material database 300. Elements that a user wants to reuse, such as the color or font style of the characters of the text, the color of the image, the layout pattern, and the style of artwork, can be acquired from the material database 300 based on input given by the user to select parameters, and artwork can be generated based on the input information and the acquired elements.

In this way, it becomes possible to create a template for an element (a non-limiting example of a second element) that the user wants to reuse, and use it to generate content.

Note that it is not necessary for the material database 300 to store all generated parameters. In a non-limiting example, elements that the user wants to reuse, such as the color or font style of the characters of the text, the color of the image, the layout pattern, and the style of the artwork, may be stored in the material database 300 based on input given by the user to select parameters.

In addition, the artwork generation device 103 may, in a non-limiting example, read out generated artwork stored in the material database 300 and output it as generated artwork.

In this way, the artwork can be reproduced.

In addition, the artwork generation device 103 generates artwork based on generated artwork selected from the generated artwork stored in the material database 300 (in a non-limiting example, the artwork generated last time) and the generated parameters used to generate the generated artwork. That is, a combination of generated parameters and generated artwork from the same past time may be selected and used to generate artwork.

In addition, the artwork generation device 103 may select two or more combinations of generated parameters and generated artwork (in a non-limiting example, the past three combinations) from the combinations of generated parameters and generated artwork stored in the material database 300 to generate artwork. All stored combinations may be used.

Note that, similarly, the parameter generation device 101 may perform generation, reproduction, and the like of parameters based on the generated parameters and generated artwork stored in the material database 300.

FIG. 3-2 is a flowchart showing an example of the flow of processing executed by the controller 100 of the information processing apparatus 1 in this example embodiment.

After step E140, the controller 100 associates the generated artwork with the generated parameters and stores them in the material database 300 in the storage (E350).

Then, the controller 100 moves to the processing of step E190.

The generated artwork and generated parameters stored in the material database 300 are used in the next and subsequent steps E130 and E140, as described above.

### Effects of Third Example Embodiment

In this example embodiment, the information processing apparatus 1 includes a material database 300 that stores generated parameters (a non-limiting example of a storage that stores a second element). The information processing apparatus 1 is configured to output content generated based on input information and generated parameters stored in the material database 300.

As an example of an effect of an example embodiment obtained by such a configuration, the second element can be stored in a storage, and content generated based on the input information and the second element stored in the storage can be output. This enables the second element to be made into a template and used to generate content, in a non-limiting example.

In addition, in this example embodiment, the information processing apparatus 1 includes the material database 300 (a non-limiting example of a storage that stores a second element) that stores generated artwork (a non-limiting example of content). The information processing apparatus 1 is configured to generate content based on at least the artwork stored in the material database 300.

As an example of an effect of an example embodiment obtained by such a configuration, content including a first element and a second element can be stored in a storage, and content can be generated based on at least the content stored in the storage. This makes it possible to reproduce generated content, in a non-limiting example.

The information processing apparatus according to the third example embodiment may incorporate a material database that cumulatively stores generated elements and content, enabling templated reuse to generate new outputs efficiently, therefore providing a transformation of storage and retrieval into an integral part of the generation process, allowing for selective recombination of historical elements like layouts or styles, which optimizes memory usage and processing speed in handling large datasets, thereby offering a specific improvement in database-driven AI systems for reproducible and scalable content creation, such as in advertisement templating, and reducing reprocessing load, and allowing the apparatus to generate new content by partial recompositing of previously stored data.

### Third Modification (1)

In the above-described example embodiment, based on input information being input by a user (first user), the information processing apparatus 1 generates artwork (first artwork) based on the input information and the generated parameters stored in the material database 300. Thereafter, based on input information being input by another user (second user), the information processing apparatus 1 can also generate artwork (second artwork) based on the input information and the generated parameters stored in the material database 300.

Also, in a non-limiting example, in addition to or instead of elements of generated parameters, elements of parameters that serve as templates created by the user may be stored in the material database 300.

Similarly, in addition to or instead of the generated artwork, artwork that serves as a template created by the user may be stored in the material database 300.

In this modification, the information processing apparatus 1 outputs content generated based on first input information obtained based on input from the first user and second elements stored in the material database 300, and outputs content generated based on second input information obtained based on input from the second user different from the first user and parameters stored in the material database 300.

As an example of the effect of the modification obtained by such a configuration, in a non-limiting example, even if different users input different input information, first content corresponding to the first input information and second content corresponding to the second input information can be appropriately generated and output based on the second elements stored in the storage.

### Fourth Example Embodiment

The fourth example embodiment is an example embodiment relating to evaluating generated artwork generated by the artwork generation device 103.

The description in the fourth example embodiment can be applied also to any of the other example embodiments and other modifications.

In addition, the same constituent elements as those already mentioned are denoted by the same reference numerals and redundant description thereof is omitted.

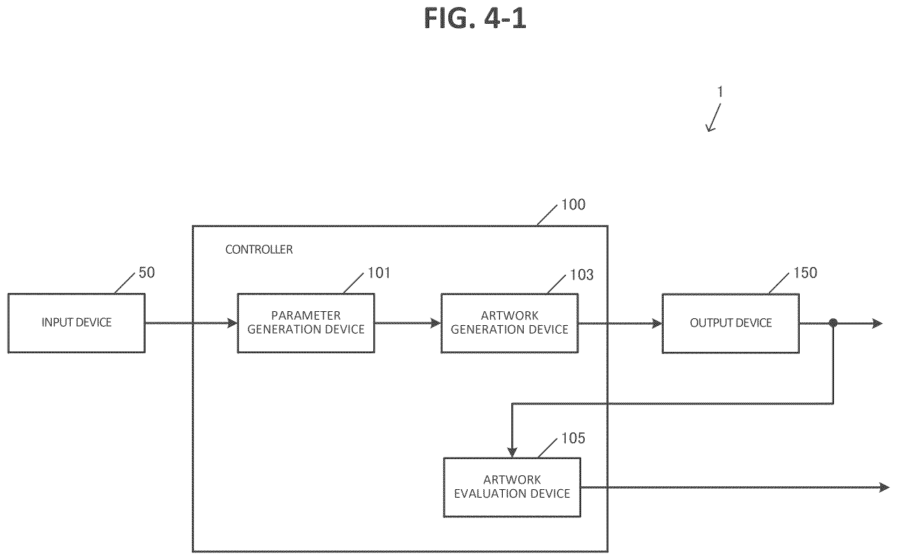

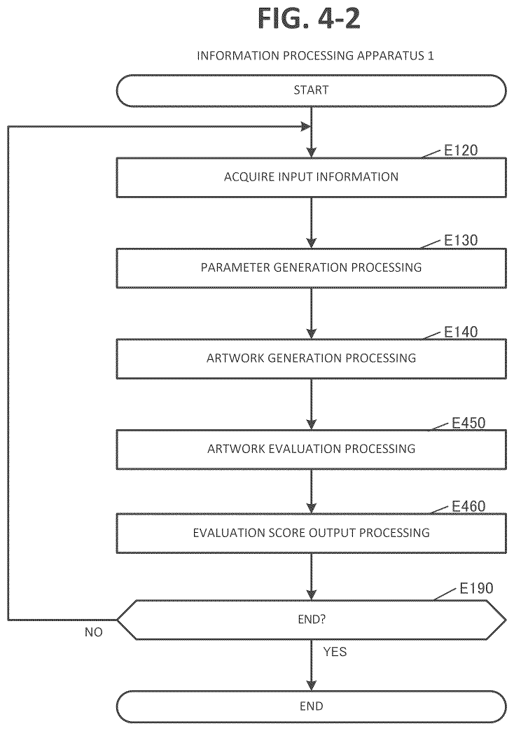

FIG. 4-1 is a block diagram showing an example of a functional configuration of the information processing apparatus 1 according to this example embodiment.

The functional blocks of this information processing apparatus 1 include a controller 100 having an artwork evaluation device 105, in addition to the configuration of FIG. 1-1.

The artwork evaluation device 105 has a function of evaluating the generated artwork.

The artwork evaluation device 105 may be realized by, in a non-limiting example, a model capable of calculating (inferring) an evaluation score (evaluation score value) of the generated artwork.

In a non-limiting example, an evaluation score function that is manually set by a person from the perspective of the aesthetics of the artwork may be used as the evaluation score function for calculating the evaluation score.

In this case, the evaluation score function may be defined as a function that uses, as variables, the arrangement of text and images, color scheme, and the like in the artwork, in a non-limiting example. In addition, in a non-limiting example, the evaluation score function may be defined as a function in which the more aesthetically pleasing the artwork is, the higher the evaluation score is. However, there is no limitation to this.

In this case, the artwork evaluation device 105 may, in a non-limiting example, generate an evaluation score model for each piece of artwork included in a set of artwork prepared in advance, through machine learning using a combination of the artwork and an evaluation score calculated for that artwork using an evaluation score function as a training dataset. The model generated in this way is called a “trained evaluation score model”.

The artwork evaluation device 105 may then, in a non-limiting example, use the generated artwork as input to a trained evaluation score model to infer an evaluation score.

Note that the evaluation score model is not limited to a machine learning model, and may be, in a non-limiting example, a mathematical statistical model such as a linear or nonlinear regression model, or a neural network model such as a DNN.

In addition, in a non-limiting example, as shown in the example display screen, the artwork may be an advertisement, and an evaluation score for the advertisement may be calculated.

In this case, the artwork evaluation device 105 may, in a non-limiting example, generate a trained evaluation score model for each advertisement included in a set of advertisements prepared in advance, through machine learning using a combination of the advertisement and an evaluation score calculated for that advertisement using an evaluation score function as a training dataset.

In this case, the inferred evaluation score can be used as information for evaluating and analyzing the effectiveness of the advertisement, such as the promotional effect of the advertisement or the sales promotion effect of the advertised product (which may also be called effectiveness information related to the effectiveness of the advertisement).

Also, unlike this example embodiment, instead of the information processing apparatus 1 calculating the evaluation score, an external apparatus with which the information processing apparatus 1 can communicate may calculate the evaluation score, and the information processing apparatus 1 may acquire the evaluation score by receiving the evaluation score from the external apparatus.

In this case, the information processing apparatus 1 may transmit evaluation score request information including the generated artwork to the external apparatus, and the external apparatus may calculate the evaluation score and transmit it to the information processing apparatus 1.

### Processing

FIG. 4-2 is a flowchart showing an example of a flow of processing executed by the controller 100 of the information processing apparatus 1 in this example embodiment.

After step E140, the artwork evaluation device 105 performs artwork evaluation processing (E450).

Specifically, in a non-limiting example, an evaluation score for the generated artwork is calculated based on the above-described technique. The calculated evaluation score is then stored in a storage (not shown).

Next, the controller 100 performs evaluation score output processing for outputting the calculated evaluation score (E460).

In this case, the calculated evaluation score may be displayed on a display (not shown), or may be transmitted to an external apparatus by a communication device.

Then, the controller 100 moves to the processing of step E190.

### Effects of Fourth Example Embodiment

In this example embodiment, the information processing apparatus 1 is configured to acquire an evaluation score of content such as artwork.

As an example of an effect of the example embodiment obtained by such a configuration, it becomes possible to obtain an index value for evaluating the generated content (content including the first element and the second element).

In this case, the artwork is an advertisement, and the information processing apparatus 1 may acquire an evaluation score related to the generated advertisement (a non-limiting example of effectiveness information related to the effectiveness of the advertisement).

As an example of an effect of an example embodiment obtained by such a configuration, it becomes possible to acquire an index value for analyzing the effectiveness of the generated advertisement (advertisement including the first element and the second element).

The information processing apparatus according to the fourth example embodiment may integrate an evaluation device to compute scores for generated content based on aesthetics or effectiveness, using trained models like neural networks, therefore providing quantifiable assessment and feedback within the system, improving the reliability of content outputs like advertisements by embedding evaluation directly into the generation pipeline, which enhances model accuracy and reduces errors in real-time processing, offering a technological solution for quality control in automated design tools.

### Fourth Modification (1)

In the above-described example embodiment, in a non-limiting example, a business may generate a plurality of advertisements using the information processing apparatus 1, and post the generated advertisements on its own homepage or distribute them to terminals using an application such as a messaging application.

In this case, the information processing apparatus 1 may calculate and aggregate the conversion rates for the respective advertisements.

Then, the information processing apparatus 1 may estimate an expected conversion rate for a newly-generated advertisement.

In addition, as the above-described evaluation score model, a model capable of estimating the relationship between the advertisement to be generated and the expected conversion rate may be used.

In this way, it is possible to estimate (predict) the conversion rate of the generated advertisement.

### Fifth Example Embodiment

The fifth example embodiment is an example embodiment related to optimizing the parameter generation device 101 and the artwork generation device 103.

The description in the fifth example embodiment can be applied to any of the other example embodiments and other modifications.

In addition, the same constituent elements as those already mentioned are denoted by the same reference numerals and redundant description thereof is omitted.

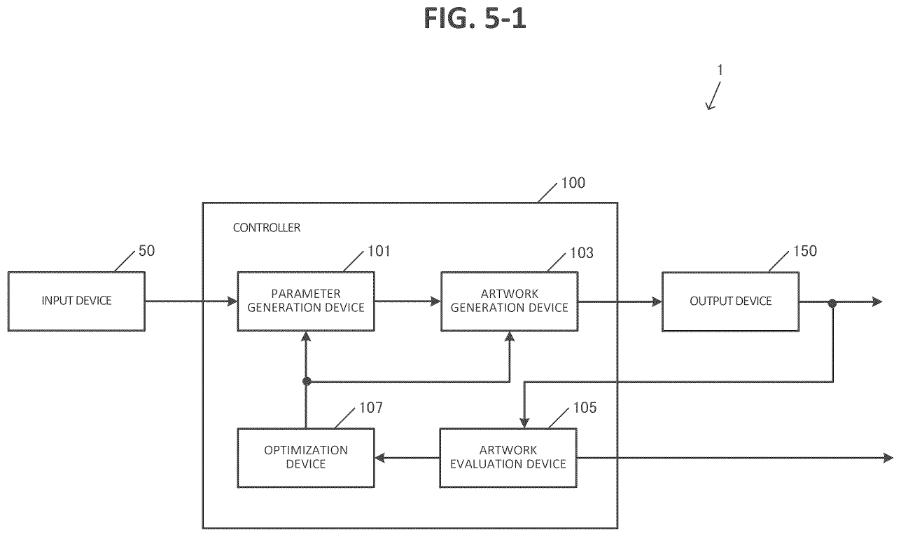

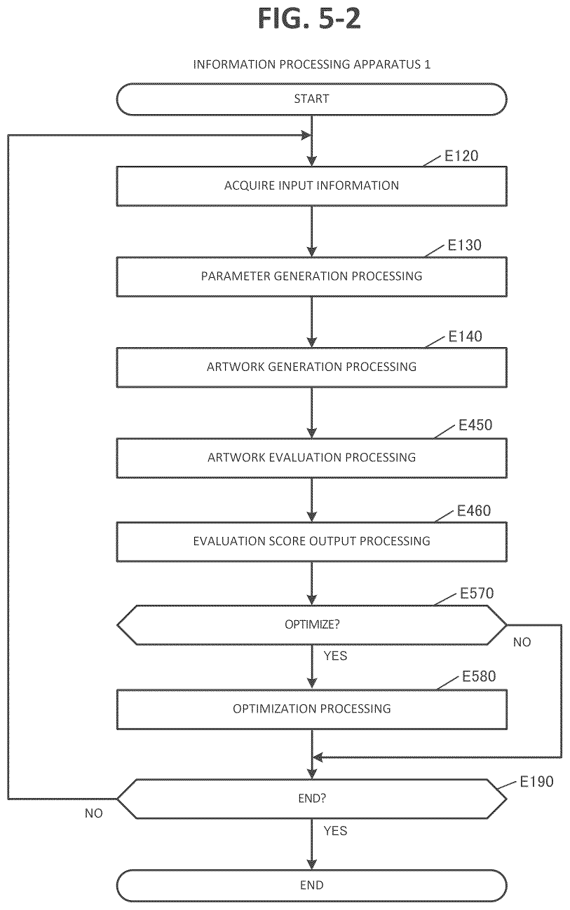

FIG. 5-1 is a block diagram showing an example of a functional configuration of the information processing apparatus 1 according to this example embodiment.

The functional blocks of the information processing apparatus 1 include the controller 100 having an optimization device 107 in addition to the configuration of FIG. 4-1.

The optimization device 107 optimizes the functional device to be optimized (in a non-limiting example, at least one functional device of the parameter generation device 101 and the artwork generation device 103) based on the evaluation results such as the evaluation score calculated by the artwork evaluation device 105.

In this case, the optimization device 107 may, in a non-limiting example, use the artwork generation history (including the history of the evaluation score) to, in a non-limiting example, optimize parameters associated with the functional device to be optimized in a direction that increases the evaluation score (where the larger the evaluation score is, the higher the evaluation of the artwork is).

As one method, the optimization device 107 may adjust hyperparameters of the model of the functional device to be optimized (in a non-limiting example, parameters related to the neural network model of the functional device to be optimized, etc.).

In this case, in a non-limiting example, a set of candidate hyperparameter values may be prepared, and a combination of hyperparameter values that changes in the direction of increasing the evaluation score may be determined using techniques such as random search, grid search, or genetic algorithms.

Note that, in a non-limiting example, the technique of the second example embodiment can be applied such that the information processing apparatus 1 acquires input information that is based on artwork generated by the artwork generation device 103, and generates artwork based on the acquired input information.

In this case, the information processing apparatus 1 can, in a non-limiting example, generate artwork based on input information acquired from the artwork that was generated last time, in a non-limiting example, using a functional device optimized based on evaluation information of artwork generated in the past.

Since optimization is performed based on evaluation information of the artwork, in this example, the information processing apparatus 1 may be regarded as acquiring input information that is based on the first artwork and generating the second artwork based on the acquired input information and the evaluation information of the artwork.

Also, similarly to the fourth example embodiment, the artwork may be an advertisement, and the artwork evaluation device 105 may infer an evaluation score for the advertisement. Then, in a non-limiting example, the optimization device 107 may adjust the hyperparameters of the model of the functional device to be optimized.

Note that in this case as well, in a non-limiting example, the method of the second example embodiment may be applied, and the information processing apparatus 1 may acquire input information that is based on the advertisement generated by the artwork generation device 103, and generate the advertisement based on the acquired input information.

Since optimization is performed based on evaluation information of the advertisement (an example of effectiveness information related to effectiveness of the advertisement), in this example, the information processing apparatus 1 may be regarded as acquiring input information that is based on the first advertisement and generating the second advertisement based on the acquired input information and the effectiveness information related to the effectiveness of the advertisement.

Also, unlike this example embodiment, instead of the information processing apparatus 1 calculating the evaluation score, an external apparatus with which the information processing apparatus 1 can communicate may calculate the evaluation score, and the information processing apparatus 1 may acquire the evaluation score by receiving the evaluation score from the external apparatus.

In this case, the information processing apparatus 1 may transmit evaluation score request information including the generated artwork to the external apparatus, and the external apparatus may calculate the evaluation score and transmit it to the information processing apparatus 1.

### Processing

FIG. 5-2 is a flowchart showing an example of a flow of processing executed by the controller 100 of the information processing apparatus 1 in this example embodiment.

After step E460, the controller 100 determines whether or not optimization is to be performed (E570).

In this case, in a non-limiting example, optimization may be performed if a condition such as the following is satisfied.
There was user input instructing optimization.
A condition related to the number of times artwork has been generated (in a non-limiting example, the number of times artwork has been generated since the last optimization was performed has reached the set number of times, etc.) has been satisfied.
A time-related condition (in a non-limiting example, the time or date for performing optimization has arrived, a set amount of time has passed since the last optimization, etc.) has been satisfied.

If it is determined that optimization is not to be performed (E570: NO), the controller 100 advances the processing to step E190.

If it is determined that optimization is to be performed (E570: YES), the controller 100 performs optimization processing (E580).

Specifically, in a non-limiting example, based on generation history data (not shown) in which artwork stored in a storage is associated with an evaluation score, and based on the above-mentioned procedure, at least one of the functional devices of the parameter generation device 101 and the artwork generation device 103 is optimized.

Then, the controller 100 moves to the processing of step E190.

### Effects of Fifth Example Embodiment

This example embodiment shows a configuration in which the information processing apparatus 1 optimizes the parameter generation device 101 based on the generated artwork.

As an example of the effect of the example embodiment obtained by such a configuration, it is possible to optimize the functional device that generates elements to be included in the content, based on the generated content.

In addition, this example embodiment shows a configuration in which the information processing apparatus 1 optimizes the artwork generation device 103 based on the generated artwork.

As an example of the effect of an example embodiment obtained by such a configuration, it is possible to optimize the functional device that generates the content based on the generated content.

In addition, this example embodiment shows a configuration in which the information processing apparatus 1 acquires input information that is based on first artwork (a non-limiting example of the first content) generated by the artwork generation device 103, and outputs second artwork (a non-limiting example of the second content) generated using the first element and the second element based on the acquired input information and the evaluation score.

As an example of an effect of an example embodiment obtained by such a configuration, it is possible to output second content generated based on acquired input information that is based on the first content and evaluation information of the first content.

In this case, the artwork is an advertisement, and the information processing apparatus 1 is configured to acquire input information that is based on the first advertisement generated by the artwork generation device 103 and an evaluation score of the first advertisement, and output a second advertisement generated based on the acquired input information and the acquired evaluation score.

As an example of an effect of an example embodiment obtained by such a configuration, a second advertisement generated based on acquired input information that is based on the first advertisement and effectiveness information related to the effectiveness of the first advertisement can be output.

The information processing apparatus according to the fifth example embodiment may include an optimization device that adjusts hyperparameters of generation models based on evaluation scores, creating a self-improving system for future content creation, therefore providing adaptive learning loops, such as those using genetic algorithms, to refine AI processes like element and artwork generation, thereby increasing computational efficiency and output quality over time, particularly for applications like advertisement optimization, representing a specific technological enhancement in machine learning-driven content systems.

### Fifth Example Embodiment (1)

The content of the fourth modification (1) may be applied to the above-described example embodiment, and the information processing apparatus 1 can estimate an expected conversion rate for a newly-generated advertisement.

In addition, as the above-described evaluation score model, a model capable of estimating the relationship between the advertisement to be generated and the expected conversion rate may be used.

Then, parameters associated with the functional devices to be optimized may be optimized in the direction of increasing the expected conversion rate.

In this way, it is possible to optimize the functional device associated with generating an advertisement based on the conversion rate.

### Application Example

As a specific configuration to which example embodiments and the information processing apparatus 1 described in the above example embodiment are applied, any of the following may be applied, in a non-limiting example.
(1) Stand-alone
(2) Client-server system

(1) In a stand-alone configuration, the information processing apparatus 1 may be, in a non-limiting example, a terminal, a server, or the like.

A terminal may include, in a non-limiting example, a smartphone, a mobile terminal (feature phone), a computer (in a non-limiting example, a desktop, laptop, tablet, etc.), a media computer platform (in a non-limiting example, a cable or satellite set-top box, a digital video recorder), a handheld computer device (in a non-limiting example, a personal digital assistant (PDA), an email client, etc.), a wearable terminal (in a non-limiting example, a glasses-type device, a watch-type device, etc.), a virtual reality (VR) terminal, a smart speaker (a device for voice recognition), or any other type of computer or communication platform. The terminal may also be expressed as an information processing terminal.

A server may include, in a non-limiting example, a server appliance, a computer (in a non-limiting example, a desktop, laptop, tablet, etc.), a media computer platform (in a non-limiting example, a cable or satellite set-top box, or a digital video recorder), a handheld computer device (in a non-limiting example, a personal digital assistant (PDA), email client, etc.), or any other type of computer or communication platform.

In addition, the server and the terminal may or may not be expressed as information processing apparatuses.

In a non-limiting example, when a user performs the various inputs described above via the operation device of the information processing apparatus 1, artwork may be generated and the generated artwork may be displayed on the display of the information processing apparatus 1.

Note that in this configuration, in a non-limiting example, at least one of the generated parameters and the generated artwork generated by the information processing apparatus 1 may be transmitted to a terminal owned by the user.

(2) In a client-server system, in a non-limiting example, it is possible to configure a system in which the above-described content is realized by using the information processing apparatus 1 as a server and communicating with the terminal of the user. The terminal and server may be the same apparatuses as those described above.

An example of processing in this case will be described below.

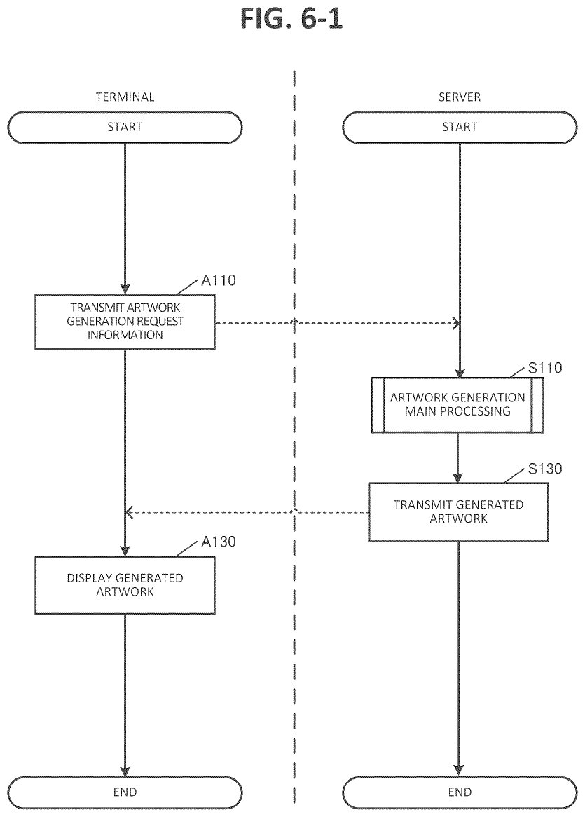

FIG. 6-1 is a flowchart showing an example of a flow of processing executed by each device in this example embodiment.

In this diagram, the left side shows the processing executed by the controller (not shown) of the terminal of the user, and the right side shows the processing executed by the controller (not shown) of the server.

The controller of the terminal transmits artwork generation request information to the server via a communication device (not shown) based on input given by a user to an input device (not shown) (A110).

The artwork generation request information may include information by which the user or the terminal can be identified, as well as text (text data) and images (image data) input by the user.

As mentioned above, the information may also include information on conditions input by the user.

When the controller of the server receives artwork generation request information from the terminal via a communication device (not shown), it performs artwork generation main processing (S110).

As the artwork generation main processing, various types of processing exemplified as processing performed by the information processing apparatus 1 in each of the above-described example embodiments and modifications can be applied.

Next, the controller of the server transmits the generated artwork to the terminal via the communication device (S130).

Then, the controller of the server ends the processing.

After A110, when the communication device receives the generated artwork from the server, the controller of the terminal displays the received generated artwork on the display (not shown) (A130).

Then, the controller of the terminal ends the processing.

Note that the server may perform the parameter generation processing in step S100 and then transmit the generated parameters to the terminal. The terminal may then display the received generated parameters on a display.

In this case, the server transmits the keywords and the like included in the parameters to the terminal, and the terminal displays the received keywords and the like on the display. The terminal may then transmit keyword selection information or keyword editing information to the server based on input performed by the terminal user to select or edit a keyword. The server may then perform artwork generation processing based on the received information.

In addition, in step S110, the server may generate a plurality of pieces of artwork, and in step S130, the generated plurality of pieces of artwork may be transmitted to the terminal. The terminal may then display the received plurality of pieces of artwork on the display.

In this case, the terminal may determine the final artwork based on input performed by the user of the terminal to select at least one piece of artwork from among the plurality of pieces of artwork, and may store the final artwork in the storage. In this case, the terminal may transmit artwork selection information to the server, and the server may determine the final artwork based on the received information and store the final artwork in the storage.

Note that these processes may be realized by an application (in a non-limiting example, an artwork generation application (the above-described advertisement generation application, etc.)).

In addition, the application may be a native application, a web application, or a hybrid application.

In addition, at least some of the processing described as being performed by the controller of the server may be performed by the controller of the terminal.

### Other

When using an application such as an advertisement generation application, the server for distributing the application (the server from which the terminal downloads the application) may be configured as a server different from the server or the like that provides the corresponding service (application). That is, the server for application distribution and the server for performing application management processing and the like may be configured as physically separated servers, or may be configured as a single server.

In addition, applications are not limited to programs of various applications, but may also include, in a non-limiting example, a program for providing a function of another service as one function of the original application, a program for updating the original application, or the like. Applications may also include data used by application programs (including data for updating applications, etc.).

The example embodiments may also be realized by a system such as the distributed system described above, in which the functions of a server or server system are provided in a terminal.

At least some example embodiments are directed to an information processing apparatus that improves the efficiency and reliability of digital content generation through hardware-based coordination of multiple generation modules, structured storage and reuse of parameter data, and controlled feedback of generated content, resulting in an improved technical operation of the apparatus itself.

Any functional blocks shown in the figures and described above, such as the functional blocks included in the controller 100, may be implemented in processing circuitry such as hardware including logic circuits, a hardware/software combination such as a processor executing software, or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

It should be understood that example embodiments described herein should be considered in a descriptive sense only and not for purposes of limitation. While some example embodiments have been particularly shown and described, it will be understood by one of ordinary skill in the art that variations in form and detail may be made therein without departing from the spirit and scope of the claims.

What is claimed is:

1. An information processing apparatus, comprising:
a controller configured to,
acquire input information including at least one of a first text and a first image; and
generate content using a first element and a second element from the input information such that the content generated includes a second image; and
an output device configured to output the content generated by the controller, wherein
the first element is second text, and
the second element is different from the first element and includes at least one of: (i) a layout of the second text in the second image, and (ii) a color of the second image.

2. The information processing apparatus according to claim 1, wherein the controller is configured to generate a plurality of pieces of the content, and the information processing apparatus further comprises:
a selection device configured to select the content from among the plurality of pieces of the content based on input performed by a user.

3. The information processing apparatus according to claim 1,
wherein the controller is further configured to acquire the input information based on the content generated by the output device.

4. The information processing apparatus according to claim 1,
wherein the content is an advertisement, and
the controller is further configured to acquire effectiveness information related to an effectiveness of the advertisement.

5. A non-transitory computer readable medium storing a program that when executed by an information processing apparatus, configures the information processing apparatus to,
acquire input information including at least one of a first text and a first image;
generate content using a first element and a second element from the input information such that the content that is generated includes a second image; and
output the content, wherein
the first element is second text, and
the second element is different from the first element and includes at least one of: (i) a layout of the second text in the second image, and (ii) a color of the second image.

6. An information processing method for an information processing apparatus, the method comprising:
acquiring, by a controller of the information processing apparatus, input information including at least one of a first text and a first image;
generating, by the controller of the information processing apparatus, content using a first element and a second element from the input information such that the content generated by the output device includes a second image; and
outputting, by an output device of the information processing apparatus, the content generated by the controller, wherein
the first element is second text, and
the second element is different from the first element and includes at least one of: (i) a layout of the second text in the second image, and (ii) a color of the second image.

7. The information processing apparatus according to claim 1,
wherein the layout is based on a layout pattern generated based on a designation by a user of the information processing apparatus.

8. The information processing apparatus according to claim 1,
wherein the layout is based on a layout pattern generated based on at least one of the input information and the first element.

9. The information processing apparatus according to claim 1,
wherein the second element includes a color of the second image, and
the color of the second image includes a color of the second text in the second image.

10. The information processing apparatus according to claim 1,
wherein the input information further includes a style of the content, and
the second element is based on the input information.

11. The information processing apparatus according to claim 10,
wherein the second element includes a color of the second image, the color being based on the input information.

12. The information processing apparatus according to claim 10,
wherein the second element further includes a font style of the second text in the second image.

13. The information processing apparatus according to claim 1,
wherein a prompt sentence for generating the first element or the second element is generated based on the input information, and
the first element or the second element is generated based on the prompt sentence.

14. The information processing apparatus according to claim 1,
wherein the controller is configured to generate at least one of the first element and the second element, and the content.

15. The information processing apparatus according to claim 1,
wherein the content is generated using a large-scale language model and an image generation model.

16. The information processing apparatus according to claim 1, wherein the controller is configured to generate the content using a large-scale language model to generate the second text based on a prompt sentence derived from the input information, and an image generation model to generate the second image incorporating the second text according to the second element.

17. The information processing apparatus according to claim 1, further comprising:
a storage device configured to store previously generated ones of the second element, wherein
the controller is configured to generate the content based on the input information and at least one second element retrieved from the storage device.

18. The information processing apparatus according to claim 1, wherein the controller includes an image recognition model configured to extract text data or features from the first image to derive the first element or the second element.

19. The information processing apparatus of claim 1, wherein the first element and the second element are parameters used to generate the content, the controller is configured to store, within a material database, the content and the parameters used to generate the content, and
the controller is configured to generate new content by adjusting at least one of the parameters used to generate the content.

20. The information processing apparatus of claim 19, wherein the parameters include at least one of a layout pattern, a font style, or a color scheme, and wherein
the controller is configured to adjust the at least one of the parameters to generate the new content based on a refinement request from a user.
